(19) United States
(12) Patent Application Publication
(10) Pub. No.: US 2017/0350044 A1
(43) Pub. Date: Dec. 7, 2017

(54) FIBER PRODUCT AND METAL FIBER

(71) Applicant: Panasonic Intellectual Property Management Co., Ltd., Osaka (JP)

(72) Inventors: Kazushige SUGITA, Hyogo (JP); Masahiro MATSUMOTO, Osaka (JP); Taisuke SHIMAZU, Kyoto (JP); Tomohiro KANAZAWA, Osaka (JP)

(21) Appl. No.: 15/609,431

(22) Filed: May 31, 2017

(30) Foreign Application Priority Data
Jun. 3, 2016 (JP) 2016-111899

(51) Int. Cl. D02G 3/12; D02G 3/04; A41D 19/00; D04B 1/28; D02G 3/38

(52) U.S. Cl. CPC D02G 3/12; D04B 1/28; D02G 3/38; A41D 19/00; D02G 3/04; A41D 2500/10; A41D 2500/20

(57) ABSTRACT

A metal fiber included in a fiber product includes a tungsten wire having a diameter less than or equal to 22 μm. The tungsten wire may have, for example, a diameter less than or equal to 18 μm. The tungsten wire may have, for example, a diameter within a range from 20% less than 13 μm to 20% greater than 13 μm. In addition, the tungsten wire may have, for example, a diameter greater than or equal to 5 μm. Further, the tungsten wire may include, for example, pure tungsten. Moreover, the metal fiber may be, for example, a metal thread including a false-twisted yarn which is made of a chemical fiber and is wound.

### CROSS REFERENCE TO RELATED APPLICATION

This application claims the benefit of priority of Japanese Patent Application Number 2016-111899 filed on Jun. 3, 2016, the entire content of which is hereby incorporated by reference.

### BACKGROUND

### 1. Technical Field

The present disclosure relates to a fiber product and a metal fiber used in the fiber product.

### 2. Description of the Related Art

Metal line materials are used for various products such as electrical products. Fiber products using a metal line material as a metal fiber are conventionally known. As a fiber product of this type, for example, Japanese Unexamined Patent Application Publication No. 2011-84822 discloses a fiber fabric having a structure in which metal fibers including a metal line material such as copper are used as warps and wefts and knitted in a net-like state.

### SUMMARY

However, with a fiber product formed using a conventional metal fiber, a desired performance is not always obtained.

An object of the present disclosure is to provide a metal fiber that may be used, for example, in a fiber product; and a fiber product including a metal fiber which can provide a desired performance.

In order to achieve the above-described object, a fiber product according to an aspect of the present disclosure includes a metal fiber including a tungsten wire having a diameter less than or equal to 22 μm.

In addition, a metal fiber according to an aspect of the present disclosure is a metal fiber that may be included in a fiber product, and includes a tungsten wire having a diameter less than or equal to 22 μm.

According to the present disclosure, it is possible to implement a fiber product including a metal fiber which can provide a desired performance, and a metal fiber which can implement such a fiber product.

### BRIEF DESCRIPTION OF DRAWINGS

The figures depict one or more implementations in accordance with the present teaching, by way of examples only, not by way of limitations. In the figures, like reference numerals refer to the same or similar elements.

FIG. 1 illustrates an external view of a glove as an example of a fiber product according to an embodiment; and

FIG. 2 is a schematic diagram which illustrates a metal fiber for use in the fiber product according to the embodiment.

### DETAILED DESCRIPTION OF THE EMBODIMENT

Hereinafter, embodiments of the present disclosure will be described with reference to the drawings. It should be noted that the subsequently-described embodiment shows a specific example of the present disclosure. Thus, the numerical values, shapes, materials, structural components, the disposition and connection of the structural components, and others described in the following embodiment are mere examples, and do not intend to limit the present disclosure. Furthermore, among the structural components in the following exemplary embodiment, components not recited in the independent claims which indicate the broadest concepts of the present disclosure are described as arbitrary structural components. In addition, each of the diagrams is a schematic diagram and thus is not necessarily strictly illustrated.

### Embodiment

A fiber product according to the embodiment includes a metal fiber made of a metal material. In other words, a fiber product according to the embodiment is manufactured using a metal fiber. For example, the fiber product is manufactured including a metal fiber that is used as a knitting yarn or a weaving yarn.

The metal fiber included in the fiber product is formed using a metal line (metal line material) including a tungsten wire. In other words, the metal fiber includes the tungsten wire. More specifically, the metal fiber includes the tungsten wire as a majority material.

The metal fiber may include only the tungsten wire which is a single line, or may be a composite line having a structure in which a plurality of tungsten wires each of which is a single line are twisted or paralleled. In addition, the metal fiber may be a composite line having a structure in which a tungsten wire that is a single line and a metal line of a different type are twisted or paralleled, or a composite line including a tungsten wire and a fiber other than a metal fiber (for example, a chemical fiber).

The tungsten wire may comprise pure tungsten. Alternatively, the degree of purity of tungsten may be 99.9% or higher. Alternatively, the degree of purity of tungsten may be 95% or higher. The degree of purity of tungsten is not limited to these examples.

The tungsten wire (tungsten fiber) included in the metal fiber is an ultrafine metal thin line, and the single line of the tungsten wire has a diameter less than or equal to 22 μm. In this case, the single line of the tungsten wire may have a diameter within a range from 20% less than 18 μm to 20% greater than 18 μm, to include a tolerance. More specifically, the single line of the tungsten wire may have a diameter greater than or equal to 14.4 μm and less than or equal to 21.6 μm.

Examples of the single line of the tungsten wire may have a diameter less than or equal to 18 μm. Other examples of the single line of the tungsten wire may have a diameter within a range from 20% less than 13 μm to 20% greater than 13 μm. More specifically, the single line of the tungsten wire may have a diameter greater than or equal to 10.4 μm and less than or equal to 15.6 μm. Another example of a diameter of the single line of the tungsten wire is within 1 μm of 13 μm. In the embodiment, a diameter of the single line of the tungsten wire which is used is 13 μm. The single line of the tungsten wire may also have a diameter greater than or equal to 5 μm.

Such an ultrafine tungsten wire can be manufactured, for example, in such a manner as described below. First, a tungsten powder having a grain size of 5 μm is press-molded and sintered to be in a form of an ingot. Next, the tungsten in the form of the ingot is subjected to swaging processing in which the tungsten ingot is press-forged from its periphery and extended to be in a form of a wire. Then, plastic deformation is caused by repeatedly performing drawing (wire drawing) using wire drawing dies having gradually reduced pore diameters, thereby manufacturing the ultrafine tungsten wire.

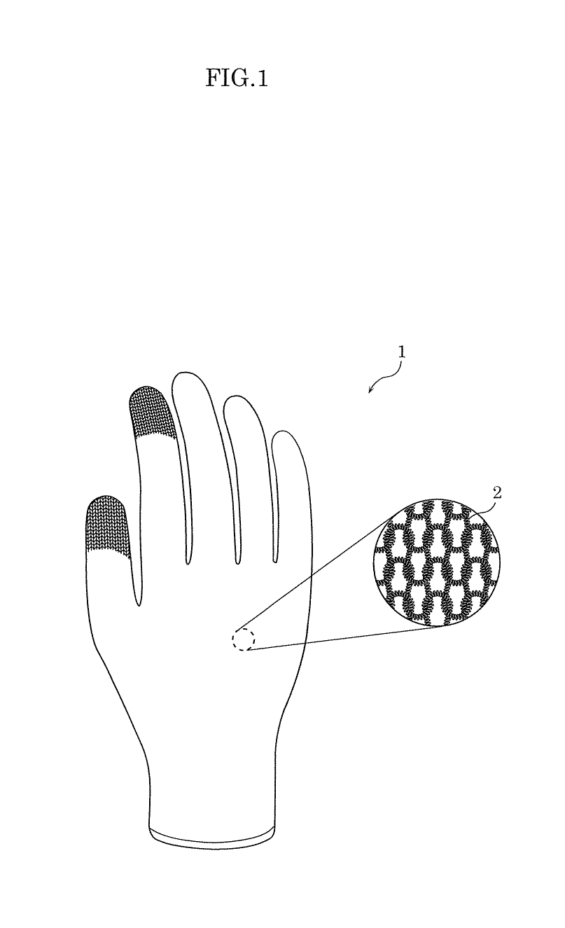

An example of a fiber product formed using a metal fiber including such an ultrafine tungsten wire includes a glove as illustrated in FIG. 1. FIG. 1 illustrates an external view of glove 1 as an example of the fiber product according to the embodiment. It should be noted that, although mesh design is illustrated on only the tips of a thumb and an index finger in FIG. 1, the entirety of glove 1 may be provided as a mesh (net-like) design.

As illustrated in FIG. 1, glove 1 is a work glove, for example, and includes a palm portion and five finger portions. Glove 1 can be manufactured by performing knitting processing such as stockinet with a predetermined gauge, using metal fiber 2 as a knitting yarn. In the example, metal fiber 2 may be a composite line including a tungsten wire (e.g., having a single line diameter of 13 μm) made of pure tungsten and a chemical fiber.

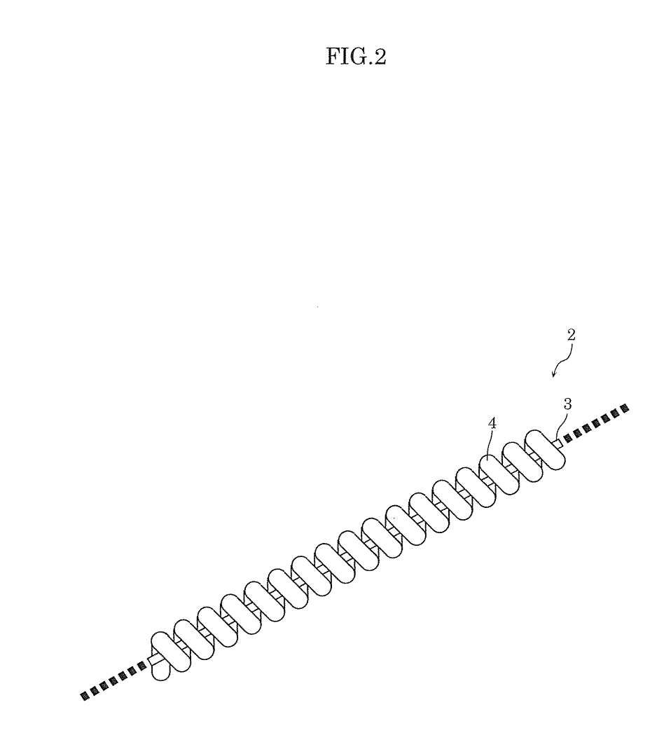

Here, a specific configuration of metal fiber 2 used for glove 1 is described with reference to FIG. 2. FIG. 2 is a schematic diagram which illustrates metal fiber 2 used for a fiber product according to the embodiment.

As illustrated in FIG. 2, metal fiber 2 is a metal thread including tungsten wire 3 as a core line, and false-twisted yarn 4 which is made of a chemical fiber and wound around tungsten wire 3. Glove 1 is knitted using metal fiber 2 as a raw thread.

As the chemical fiber included in false-twisted yarn 4 of metal fiber 2, a synthetic fiber such as polyester, acrylic, or nylon is used, for example. The chemical fiber is not limited to the synthetic fiber, and a reclaimed fiber of rayon or a semisynthetic fiber may be used. In addition, a natural fiber may be used instead of the chemical fiber.

It should be noted that, the composite line including the tungsten wire and the chemical fiber has a configuration not limited to the configuration illustrated in FIG. 2, and may have a configuration in which threads including the tungsten wire and the chemical fiber are twisted or paralleled.

In addition, although glove 1 is described as an example of a fiber product using a metal fiber according to the embodiment, the fiber product is not limited to this example.

For example, the fiber product may be a fiber fabric using a metal fiber including a tungsten wire having a diameter less than or equal to 13 μm. The fiber fabric may be a knitted fabric, a woven fabric, a non-woven fabric, etc., including a metal fiber as the raw thread. A knitted fiber fabric can be manufactured by, for example, applying knitting processing to a metal fiber. In addition, a woven fiber fabric can be manufactured by, for example, applying weaving processing to a metal fiber. The fiber fabric may have a cloth-like shape or a sheet-like shape. However, the shape of the fiber fabric is not limited to these examples.

In addition, examples of the fiber product using the metal fiber may include clothes, headwear, shoes, socks, etc. Examples of the clothes include general clothes such as a blouse, a shirt, bottoms, a jumper, a jacket, down wear, a vest, a parka, an anorak, a coat, a rain coat, a windbreaker, ski wear, snowboard wear, etc., or working clothes used in a work place such as a construction site, a factory, etc. However, the clothes are not limited to these examples. It should be noted that, when the fiber product is a product worn by a person, such as clothes, headwear, shoes, socks, or the like, the metal fiber may be a composite line including a tungsten wire and a chemical fiber as illustrated in FIG. 2.

In addition, examples of the fiber product using the metal fiber are not limited to the above-described examples, and may include other fiber products such as a tent, a sleeping bag, a bag, a flag, etc.

In addition, examples of the fiber product using the metal fiber are not limited to consumer products, and may be industrial products such as a film sheet. In this case, the metal fiber may include only the tungsten wire, or may be a composite line including the tungsten wire and a chemical fiber. In this case, it is possible to obtain an insulating sheet which includes a conductive metal (tungsten wire), by performing knitting processing or weaving processing using a metal fiber including the tungsten wire and a chemical fiber having insulation properties.

The metal fiber according to the present embodiment can be used for other various products. For example, the metal fiber may be used like cotton in a fiber product. More specifically, it is possible to obtain a fiber product in which metal fibers each including the tungsten wire are randomly spread.

It should be noted that use of the metal fiber according to the present embodiment is not limited to the fiber products, and the metal fiber according to the present embodiment may be used for products other than the fiber products.

The following describes an advantageous effect of the metal fiber and the fiber product according to the present embodiment, together with circumstances leading to the present disclosure.

A stainless steel line or the like is conventionally known as an ultrafine metal line. Metal lines tend to easily break off and become difficult to handle when the diameters of the metal lines are small. Accordingly, the diameter of an ultrafine metal line is set to approximately 50 μm at best, and a product including a metal line having a diameter less than or equal to 50 μm is limited to very few products.

Above all, fiber products require knitting processing, weaving processing, or the like, and thus it has been difficult to manufacture fiber products using a metal line having a diameter less than or equal to 50 μm. In particular, it is difficult to manufacture fiber products using a metal line having a diameter less than 25 μm, and manufacturing of fiber products using a metal line having a diameter less than or equal to 15 μm has been extremely difficult.

In view of the above, the inventors of the present disclosure have been developing a metal line using not a stainless steel line but a metal material other than the stainless steel line. As a result of earnest investigation, the inventors have found a metal line suitable for a metal fiber that is to be a raw thread of fiber products, by using tungsten. More specifically, it has been found out that a metal line (tungsten wire) which is high in tensile strength and hardness, and is easily bent can be obtained by using tungsten as a material of the metal line.

In this regard, as a result of various studies by the inventors, it has been found out that the tensile strength of the tungsten wire is increased as a result of work-hardening by repeatedly performing wire drawing using wire drawing dies in the process of making the line ultrafine. In other words, it has been found out that use of the tungsten wire makes it possible to obtain a metal line that is less likely to break off even when the metal line is made ultrafine, or rather, to obtain a strong metal line by making the metal line ultrafine.

For example, when a tungsten wire which includes pure tungsten and has a single line diameter of 13 μm and a stainless steel line which includes SUS304 and has a single line diameter of 13 μm are manufactured, it has been found out that the tungsten wire (φ13 μm) has the tensile strength of approximately 4000 (N/mm²) and the hardness as much as 900 (HV); that is, approximately five times as much as the tensile strength of the stainless steel line (φ13 μm) and four to five times as much as the hardness of the stainless steel line (φ13 μm).

In particular, it has been found out that, by manufacturing tungsten wires having different diameters, the tensile strength and the hardness of the tungsten wire are significantly improved when the single line diameter is less than or equal to 22 μm.

In addition, a metal line generally has flexibility which increases to be easier to be bent as the metal line becomes thinner. However, it has been also found out that the tungsten wire becomes significantly easy to be bent when the single line diameter is less than or equal to 22 μm.

The fiber product and the metal fiber according to the present embodiment have been conceived on the basis of such underlying knowledge.

The fiber product according to the present embodiment is manufactured using a metal fiber including a tungsten wire having a single line diameter less than or equal to 22 μm. The tungsten wire included in the metal fiber may comprise pure tungsten.

As described above, it is possible to obtain a metal fiber that is easy to be bent, by using the tungsten wire having a single line diameter less than or equal to 22 μm. This facilitates performing of the knitting processing, the weaving processing, or the like, even when a metal fiber that is generally more difficult to be bent than a chemical fiber is used, and thus it is possible to easily manufacture a fiber product. In other words, the metal fiber including the tungsten wire having a single line diameter less than or equal to 22 μm is easy to be processed and excellent in handling ability.

In addition, it is possible, by using the tungsten wire having a single line diameter less than or equal to 22 μm, to easily manufacture a fiber product having flexibility even when the fiber product is manufactured using a metal fiber that is generally difficult to be bent. In particular, the fiber product is more excellent in flexibility than a fiber product manufactured using a tungsten wire having a single line diameter greater than 25 μm. Accordingly, it is possible to implement a fiber product which, when applied to a glove or clothes, facilitates smooth movement of a hand or a body.

Furthermore, since the tungsten wire having a single line diameter less than or equal to 22 μm is high in the tensile strength and the hardness, it is possible to obtain a strong fiber product which is excellent in durability, by manufacturing the fiber product using a metal fiber including the tungsten wire having a single line diameter less than or equal to 22 μm. For example, it is possible to maintain an original shape even when the fiber product is repeatedly bent hundreds of times or repeatedly washed a few dozen times.

In addition, it is possible to make a surface area of a metal portion of the tungsten wire having a single line diameter less than or equal to 22 μm larger than a surface area of a metal portion of a tungsten wire having a diameter greater than 25 μm. With this configuration, a fiber product manufactured using a metal fiber including the tungsten wire having a diameter less than or equal to 22 μm has a heat dissipation performance more excellent than a fiber product manufactured using a metal fiber including the tungsten wire having a diameter greater than 22 μm. Accordingly, it is possible to obtain a fiber product having an excellent heat dissipation performance, by using the tungsten wire having a diameter less than or equal to 22 μm. In particular, when the fiber product has a flat shape such as a sheet-like shape, an excellent heat dissipation performance can be obtained.

In addition, a fiber product manufactured using a metal fiber including the tungsten wire having a diameter less than or equal to 22 μm can be made lighter in weight than a fiber product manufactured using a metal fiber including the tungsten wire having a diameter greater than 25 μm.

In addition, when a metal fiber including the tungsten wire having a diameter less than or equal to 22 μm is used, it is possible to manufacture a fiber product such as a glove, clothes, etc., which feels better to the touch and against the skin compared to the case where a metal fiber including the tungsten wire having a diameter greater than 25 μm is used. More specifically, when a fiber product is touched by hand, tingling sensation is significantly felt by touching the fiber product manufactured using the tungsten wire having a diameter greater than 25 μm. However, the tingling sensation is significantly reduced when touching the fiber product manufactured using the tungsten wire having a diameter less than or equal to 22 μm.

In addition, a melting point of a tungsten wire is several times higher than a melting point of a stainless steel line (SUS304) having the same diameter. For that reason, it is possible to implement a fiber product which excels in thermal resistance.

In addition, use of a metal fiber including a tungsten wire makes it possible to implement a fiber product capable of shielding a radioactive ray.

As described above, according to the present disclosure, it is possible to implement a fiber product which can produce a desired performance, and a metal fiber which can, for example, be implemented in a fiber product.

In examples according to the present embodiment, the tungsten wire included in the metal fiber may have, for example, a diameter less than or equal to 18 μm.

In this manner, the above-described various advantageous effects significantly improve compared to a metal fiber including a tungsten wire having a diameter greater than 18 μm.

In examples according to the present embodiment, the tungsten wire included in the metal fiber may have, for example, a diameter within a range from 20% less than 13 μm to 20% greater than 13 μm.

With this configuration, it is also possible to reliably produce the above-described various advantageous effects.

In examples according to the present embodiment, the tungsten wire included in the metal fiber may have, for example, a diameter greater than or equal to 5 μm.

It has been found out that, when a fiber product is manufactured using a tungsten wire, the tungsten wire is likely to break off if the tungsten wire is made too thin. In particular, a tungsten wire is more likely to break off when the tungsten wire is manufactured using manufacturing equipment such as a knitting machine or a weaving machine. As a result of investigation by the inventors, it has been found out that, when a fiber product using a metal fiber including a tungsten wire is manufactured, it is possible to significantly reduce breaking off of a tungsten wire at the time of manufacturing the fiber product, by setting a diameter of the tungsten wire to greater than or equal to 5 μm.

In examples according to the embodiment, the metal fiber is, for example, a metal thread including a false-twisted yarn which is made of a chemical fiber and is wound.

It is difficult, in general, to knit or weave a metal line together with a chemical fiber such as a synthetic fiber. However, use of a tungsten wire having a diameter less than or equal to 22 μm makes it possible to easily knit or weave the tungsten wire together with a chemical fiber.

Furthermore, by using a metal fiber including a tungsten wire and a false-twisted yarn which is made of a chemical fiber and wound around the tungsten wire, it is possible to cover the tungsten wire by the false-twisted yarn. In this manner, when manufacturing a fiber product to be worn by a person, such as a glove, clothes, etc., it is possible to manufacture the fiber product to further feel better to the touch and against the skin. In other words, it is possible to further reduce the tingling sensation. For example, almost no tingling sensation is felt by a fiber product manufactured using a tungsten wire having a diameter of 13 μm.

(Modification)

Although the fiber product and the metal fiber according to the present disclosure have been described on the basis of the embodiment, the present disclosure is not limited to the above-described embodiment.

For example, a fiber fabric including a synthetic fiber may be stacked and bonded, using a binder resin or the like, on one surface of another fiber fabric including a metal fiber. As the binder resin, a urethane resin, an acrylic resin, a silicone resin, a polyester resin, a nylon resin, etc. may be used.

In this case, functional processing such as water repellent finishing, flame retarding, antistatic finishing, ultraviolet-ray blocking processing, bacteriostatic processing, antibacterial deodorized processing, etc. may be applied to the fiber fabric including a synthetic fiber, to provide the synthetic fiber with functionality such as water repellency, fire retardancy, antistatic property, ultraviolet-ray blocking property, antibacterial property, antibacterial deodorization property, etc. In the example where a fiber fabric including a synthetic fiber is stacked and bonded using a binder resin or the like on one surface of another fiber fabric including a metal fiber, the functional processing may be performed in advance of this stacking and bonding. It should be noted that, when the metal fiber includes a synthetic fiber such as a false-twisted yarn, such functionality may be provided to the synthetic fiber.

In addition, one surface of a fiber fabric including a metal fiber may be coated with a resin solution such as a urethane resin, an acrylic resin, a silicone resin, a polyester resin, a nylon resin, etc., or a resin layer may be formed on one surface of the fiber fabric by bonding a resin film such as an urethane resin film, a polyester resin film, an acrylic resin film, a silicone resin film, a nylon resin film, etc.

In addition, in the case of a fiber fabric including a synthetic fiber, or a metal fiber including a synthetic fiber such as a false-twisted yarn, the synthetic fiber may be colored. The fiber fabric may be colored entirely or partly.

It should be noted that the present disclosure also includes other forms in which various modifications apparent to those skilled in the art are applied to the embodiment or forms in which structural components and functions in the embodiment are arbitrarily combined within the scope of the present disclosure.

While the foregoing has described one or more embodiments and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present teachings.

What is claimed is:

1. A fiber product, comprising a metal fiber including a tungsten wire having a diameter less than or equal to 22 μm.

2. The fiber product according to claim 1,
wherein the tungsten wire has a diameter less than or equal to 18 μm.

3. The fiber product according to claim 1,
wherein the tungsten wire has a diameter within a range from 20% less than 13 μm to 20% greater than 13 μm.

4. The fiber product according to claim 1,
wherein the tungsten wire has a diameter greater than or equal to 5 μm.

5. The fiber product according to claim 1,
wherein the tungsten wire comprises pure tungsten.

6. The fiber product according to claim 1,
wherein the tungsten wire comprises a purity of 95% or higher tungsten.

7. The fiber product according to claim 1,
wherein the tungsten wire comprises a purity of 99.9% or higher tungsten.

8. The fiber product according to claim 1,
wherein the metal fiber is a metal thread including a false-twisted yarn which is made of a chemical fiber and is wound.

9. The fiber product according to claim 1,
wherein the fiber product is a glove knitted using the metal fiber as a knitting yarn.

10. The fiber product according to claim 1,
wherein the fiber product comprises multiple instances of the metal fiber in a random arrangement like cotton.

11. The fiber product according to claim 1,
wherein the fiber product is a fiber fabric.

12. The fiber product according to claim 9,
wherein the fiber fabric is either one of a woven fabric and a knitted fabric, in which the metal fiber is used as a raw thread.

13. A metal fiber, comprising:
a tungsten wire having a diameter less than or equal to 22 μm.

14. The metal fiber according to claim 13,
wherein the tungsten wire has a diameter less than or equal to 18 μm.

15. The metal fiber according to claim 13,
wherein the tungsten wire has a diameter within a range from 20% less than 13 μm to 20% greater than 13 μm.

16. The metal fiber according to claim 13,
wherein the tungsten wire has a diameter greater than or equal to 5 μm.

17. The metal fiber according to claim 13,
wherein the tungsten wire comprises pure tungsten.

18. The metal fiber according to claim 13,
wherein the tungsten wire comprises a purity of 95% or higher tungsten.

19. The metal fiber according to claim 13,
further comprising a false-twisted yarn made of a chemical fiber wound around the tungsten wire.

20. A method of manufacturing a fiber product, comprising:
providing a metal fiber comprising a tungsten wire having a diameter less than or equal to 22 μm; and
knitting or weaving the fiber product using the metal fiber.
